(19) United States
(12) Patent Application Publication
(10) Pub. No.: US 2018/0113503 A1
(43) Pub. Date: Apr. 26, 2018

(54) DEEP OFF POWER STATES

(71) Applicant: HEWLETT PACKARD ENTERPRISE DEVELOPMENT LP, Houston, TX (US)

(72) Inventors: Michael STERNS, Cypress, TX (US); Andrew BROWN, SR., Houston, TX (US)

(21) Appl. No.: 15/566,189

(22) PCT Filed: Apr. 30, 2015
(86) PCT No.: PCT/US2015/028574

§ 371 Date: Oct. 12, 2017

(51) Int. Cl. G06F 1/32

(52) U.S. Cl. CPC G06F 1/3296; G06F 1/3287; G06F 1/3206

(57) ABSTRACT

In one implementation, a system for deep off power states includes a manager engine to: receive a number of power management requests from a number of servers, determine an energy utilization for the number of servers based on the number of power management requests, and remove an electrical energy connection from a portion of the number of servers based on the energy utilization.

### BACKGROUND

Power distribution for a computing system such as a system comprising a plurality of servers (e.g., server cartridges, server blades, etc) can include utilizing a number power of distribution units (PDUs) to provide electrical energy (e.g., electrical power, electricity, etc.) to each of the plurality of servers. The PDUs can distribute electrical energy to each of the plurality of servers. The PDUs can be utilized to monitor electrical energy use for each of the plurality of servers to increase efficiency of the computing system.

### BRIEF DESCRIPTION OF THE DRAWINGS

FIG. 1 illustrates a diagram of an example of a system for providing deep off power states consistent with the present disclosure.

FIG. 2 illustrates a diagram of an example computing device consistent with the present disclosure.

FIG. 3 illustrates a diagram of an example of a system for providing deep off power states consistent with the present disclosure.

FIG. 4 illustrates a flow chart of an example of providing deep off power states consistent with the present disclosure.

### DETAILED DESCRIPTION

A number of methods and systems for providing deep off power states are described herein. In some examples, a system for providing deep off power states can include a shared computing infrastructure. The shared computing infrastructure can include a plurality of servers (e.g., cartridges, server blades, etc.) that include a shared chassis manager (e.g., manager, manager engine, etc.). The manager can be utilized to control workload and/or power utilization for the plurality of servers within the shared computing infrastructure. For example, the manager can be utilized to increase efficiency of the plurality of servers by lowering a workload of a portion of the plurality of servers when the workload can be assigned to other servers.

Lowering the workload of the portion of the plurality of servers can enable the manager to put the portion of the plurality of servers into a sleep state, hibernate state, or off state in order to conserve power utilization for the shared computing infrastructure. In these examples, the portion of the plurality of servers in a sleep state, hibernate state, or off state can still be utilizing a relatively low quantity of energy (e.g., power, electrical energy, electricity, etc.). For example, a server in a sleep state, hibernate state, or off state can utilize energy to perform a number of functions (e.g., monitor temperature, monitor workload of other servers, monitor workload to determine when to come out of the sleep state, etc.). In a specific example, a baseboard management controller and/or a NIC supporting Wake-On-LAN (WOL) can be functioning in the sleep state, hibernate state, or off state to receive power on requests that can be utilized to determine when a server should move to an “on” state.

Power utilization can be very important to data centers and other computing environments. Limited power supplies and energy cost considerations can drive greater efficiency in power utilization. The manager, as described herein, can provide deep off power states for the plurality of servers within the shared computing infrastructure. The deep off power states, as used herein, include removing all power from being provided to a number of servers. In some examples, the deep off power states can be utilized in place of a sleep state or hibernate state. That is, the deep off power state can be utilized for a number of servers that would normally be in a sleep state, hibernate state, or off state.

The deep off power states can be assigned to particular servers by the manager. That is, the manager can determine a portion of the plurality of servers that are not needed for a particular workload of the shared computing infrastructure. The manager can then put the portion of the plurality of servers in a deep off power state by utilizing an electronic power switch and/or electronic fuse. For example, the manager can be communicatively coupled to the electronic power switch and/or electronic fuse of a particular server. In this example, the manager can turn the electronic power switch to an “off” position when the particular server can be powered down and/or can be removed from utilization. In this example, the electronic power switch can remove a power connection between the particular server and a power source (e.g., power distribution unit, etc.).

Thus, when the electronic power switch is in an “off” position the electrical energy from the power source is not distributed to the particular server. When the electronic power switch is in an “on” position the electrical energy from the power source can be provided to the particular server. Thus, the manager is capable of shutting down power to a number of servers and reconnecting power to the number of servers based on a workload of the shared computing infrastructure. Furthermore, the manager can continue to monitor the workload and power management of the number of servers within the shared computing infrastructure when the number of servers are in a deep off power state.

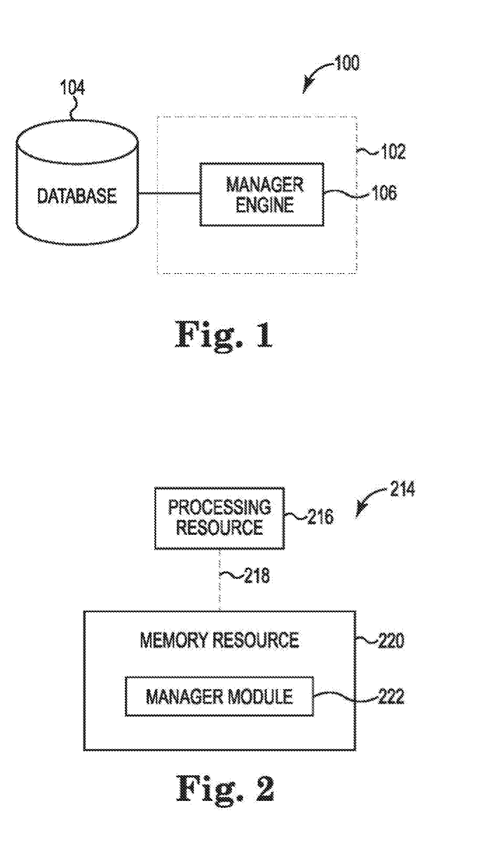

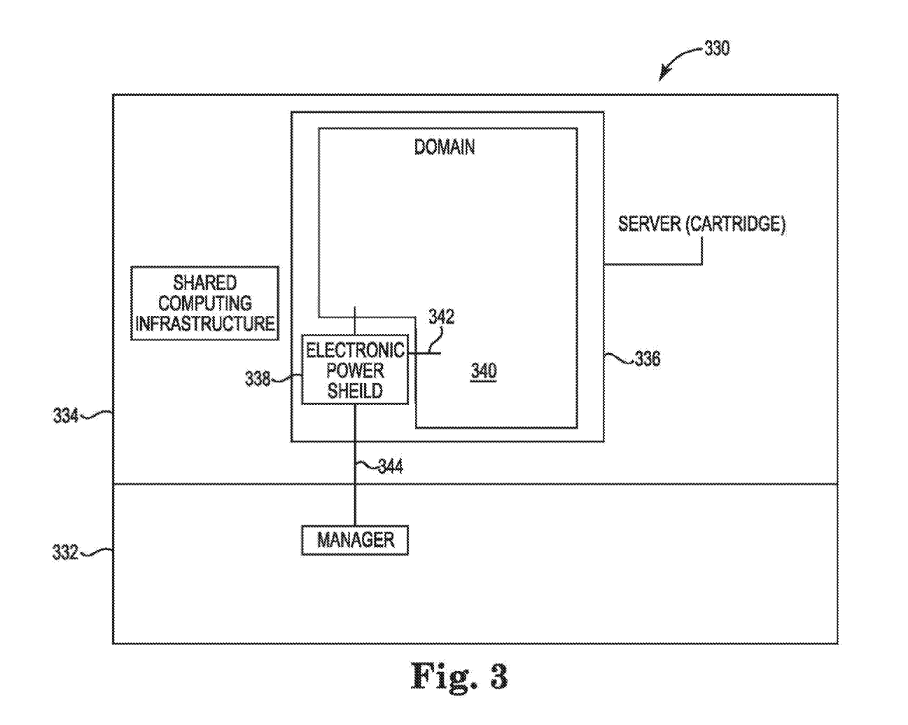

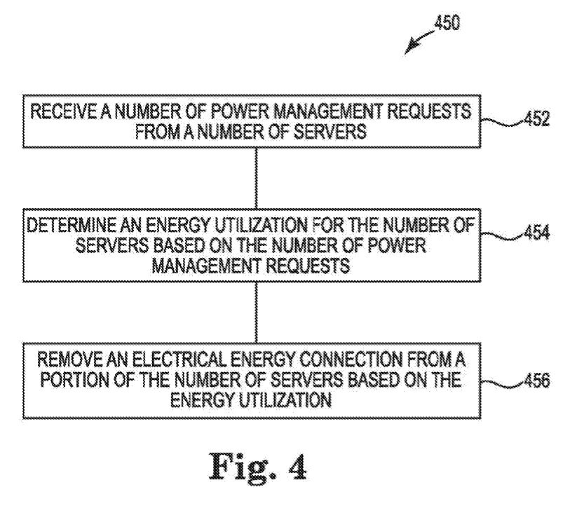

FIGS. 1 and 2 illustrate examples of system 100 and computing device 214 consistent with the present disclosure. FIG. 1 illustrates a diagram of an example of a system 100 for a providing deep off power states consistent with the present disclosure. The system 100 can include a database 104, a deep off power state system 102, and/or a number of engines (e.g., manager engine 106, etc.). The deep off power state system 102 can be in communication with the database 104 via a communication link, and can include the number of engines (e.g., manager engine 106, etc.). The deep off power state system 102 can include additional or fewer engines that are illustrated to perform the various functions as will be described in further detail in connection with FIGS. 3-4.

The number of engines (e.g., manager engine 106, etc.) can include a combination of hardware and programming, but at least hardware, that is configured to perform functions described herein (e.g., receive a number of power management requests from a number of servers, determine an energy utilization for the number of servers based on the number of power management requests, remove an electrical energy connection from a portion of the number of servers based on the energy utilization, monitor and control functionality of a number of computing devices, enable (e.g., turn on, provide power, etc.) and disable (e.g., turn off, disconnect power, etc.) the electronic power switch based on monitored functionality of the number of computing devices, etc.). The programming can include program instructions (e.g., software, firmware, etc.) stored in a memory resource (e.g., computer readable medium, machine readable medium, etc.) as well as hard-wired program (e.g., logic).

The manager engine 106 can include hardware and/or a combination of hardware and programming, but at least hardware, to receive a number of power management requests from a number of servers. As used herein the number of power management requests can include requests to power on and power off computing resources (e.g., servers, computers, blade servers, etc.). The manager engine 106 can control a number of nodes within a server. For example the manager engine 106 can have control over a plurality of server cartridges within a server rack and/or data center. The power management requests can be utilized to determine when a server cartridge can be put into a deep off power state (e.g., having all power removed, etc.) and/or put into an on state (e.g., reconnected to power supply, reconnected to power distribution unit, etc.).

In some examples, the manager engine 106 can be remotely located from the plurality of servers in the shared computing infrastructure. That is, the manager engine 106 may not be located within one or more of the servers and/or power distribution units of the shared computing infrastructure. Being remotely located from the plurality of servers can enable the manager engine 106 to continue monitoring servers of the shared computing infrastructure that are in the deep off power state and reconnect the servers that are in the deep off power slate when the servers are needed or wanted for utilization of a particular workload.

The manager engine 106 can include hardware and/or a combination of hardware and programming, but at least hardware, to determine an energy utilization for the number of servers based on the number of power management requests. The energy utilization for the number of servers can include a quantity of energy and/or power that is utilized by the number of servers. The determined energy utilization can also be based on a workload and/or functional capabilities of the shared computing infrastructure. For example, the manager engine 106 can determine that a workload for the shared computing infrastructure is below a particular threshold value. When the workload is below a particular threshold value a number of servers within the shared computing infrastructure can be put into a deep off power state when there resources are not needed for the workload below the particular threshold.

The manager engine 106 can include hardware and/or a combination of hardware and programming, but at least hardware, to remove an electrical energy connection from a portion of the number of servers based on the energy utilization. The manager engine 106 can remove an electrical energy connection by putting an electronic power switch in an “off” position. Putting the electronic power switch in an “off” position can break the connection between the portion of the number of servers and a power source such as a power distribution unit. That is, in some examples, the manager engine 106 can remove electrical energy from being transmitted to the portion of the number of servers to put the number of servers into a deep off power state.

In some examples, the manager engine 106 can receive additional power management requests relating to the portion of the number of servers when the electrical energy connection is removed. That is, the manager engine 106 can be utilized to monitor the power management requests of the portion of the number of servers when the portion of the number of servers are in a deep off power state. In some examples, the manager engine 106 can reconnect the electrical energy connection to the portion of the number of servers based on the additional power management requests.

As described herein, previous systems can put a portion of servers into an off state, standby state, and/or sleep state to conserve power. However, the portion of servers in an off state, standby state, and/or sleep state can still be utilizing power from a power distribution unit and/or power source while in these states. Even in an off state, the portion of the servers can be utilizing a relatively low quantity of power to perform a number of functions. For example, the number of functions can include, but are not limited to: temperature monitoring, workload monitoring, energy utilization monitoring, among other functions that can be performed by a server during off state, standby state, and/or sleep state.

The deep off power state set by removing the electrical connection between a power source and a portion of servers is different than the previous system off state, standby state, and/or sleep state. The deep off power state can remove all electrical energy utilization of the portion of servers that are in the deep off power state. In some examples, the deep off power state can save approximately 3.5 Watts per server cartridge. This can be advantageous with relatively larger scale systems that have limited power resources. Thus, the deep off power state can save additional power resources over the off state, standby state, and/or sleep state of previous systems.

FIG. 2 illustrates a diagram of an example computing device 214 consistent with the present disclosure. The computing device 214 can utilize software, hardware, firmware, and/or logic to perform functions described herein.

The computing device 214 can be any combination of hardware and program instructions configured to share information. The hardware, for example, can include a processing resource 216 and/or a memory resource 220 (e.g., computer-readable medium (CRM), machine readable medium (MRM), database, etc.). A processing resource 216, as used herein, can include any number of processors capable of executing instructions stored by a memory resource 220. Processing resource 216 may be implemented in a single device or distributed across multiple devices. The program instructions (e.g., computer readable instructions (CRI)) can include instructions stored on the memory resource 220 and executable by the processing resource 216 to implement a desired function (e.g., receive a number of power management requests from a number of servers, determine an energy utilization for the number of servers based on the number of power management requests, remove an electrical energy connection from a portion of the number of servers based on the energy utilization, monitor and control functionality of a number of computing devices, enable and disable the electronic power switch based on monitored functionality of the number of computing devices, etc.).

The memory resource 220 can be in communication with a processing resource 216. A memory resource 220, as used herein, can include any number of memory components capable of storing instructions that can be executed by processing resource 216. Such memory resource 220 can be a non-transitory CRM or MRM. Memory resource 220 may be integrated in a single device or distributed across multiple devices. Further, memory resource 220 may be fully or partially integrated in the same device as processing resource 216 or it may be separate but accessible to that device and processing resource 216. Thus, it is noted that the computing device 214 may be implemented on a participant device, on a server device, on a collection of server devices, and/or a combination of the participant device and the server device.

The memory resource 220 can be in communication with the processing resource 216 via a communication link (e.g., a path) 218. The communication link 218 can be local or remote to a machine (e.g., a computing device) associated with the processing resource 216. Examples of a local communication link 218 can include an electronic bus internal to a machine (e.g., a computing device) where the memory resource 220 is one of volatile, non-volatile, fixed, and/or removable storage medium in communication with the processing resource 216 via the electronic bus.

A number of modules (e.g., manager module 222, etc.) can include CRI that when executed by the processing resource 216 can perform functions. The number of modules (e.g., manager module 222, etc.) can be sub-modules of other modules. In another example, the number of modules (e.g., manager module 222, etc.) can comprise individual modules at separate and distinct locations (e.g., CRM, etc.).

Each of the number of modules (e.g., manager module 222, etc.) can include instructions that when executed by the processing resource 216 can function as a corresponding engine as described herein. For example, the manager module 222 can include instructions that when executed by the processing resource 216 can function as the manager engine 106 as referenced in FIG. 1.

FIG. 3 illustrates a diagram of an example of a system 330 for providing deep off power states consistent with the present disclosure. The system 330 can illustrate a manager 332 (e.g., manager engine, etc.) that is communicatively coupled to a shared computing infrastructure 334 (e.g., shared chassis domain, shared server domain, etc.). The manager 332 can manage a plurality of servers (e.g., server 336, server cartridges, etc.) that are within the shared computing infrastructure 334.

In some examples, the manager 332 can have complete control or partial control over the functionality of each of the number of servers within the shared computing infrastructure 334. For example, the manager 332 can control a domain 340 of the server 336. In addition, the manager 332 can monitor functionality of each of the number of servers within the shared computing infrastructure 334. Thus, the manager 332 can monitor a workload and/or energy utilization requests for the shared computing infrastructure 334 and adjust workloads and/or energy utilization for the number of servers within the shared computing infrastructure 334. For example, the manager 334 can determine, based on monitoring, that a portion of the number of servers can be put into a deep off power state as described herein.

Each of the number of servers within the shared computing infrastructure 334 can be coupled to an electronic power switch 388 via a connection 338 (e.g., power connection, power cord, etc.). The system 330 displays a server 336 coupled to the electronic power switch 388 via the connection 338. The system 330 can include a plurality of additional servers that are connected to corresponding electronic power switches similarly to the server 336. The electronic power switch 338 can couple the corresponding server 336 to a power source such as a power distribution unit coupled to a power source.

The electronic power switch 388 can be utilized to put the corresponding server 336 into a deep off power state as described herein. For example, the manager 332 can determine, based on monitoring of the shared computing infrastructure 334, that the server 336 and/or the resources associated with the server 336 are not needed for a current workload. In this example, the manager 332 can be communicatively coupled to the electronic power switch 338 via a communication link 344 (e.g. WIFI, Ethernet, near-field communication (NFC), etc.). The manager 332 can turn the electronic power switch 338 to an on position and/or an off position via the communication link 344. Electrical energy and/or power can be provided to the server 336 when the electronic power switch 338 is in an on position and electrical energy and/or power can be disconnected and/or not provided to the server 336 when the electronic power switch 338 is in an off position.

The system 330 can provide additional power and/or energy utilization savings compared to previous systems and methods by putting a portion of servers, such as server 336 into a deep off power state. The deep off power state can provide a power and/or energy utilization savings of approximately 3.5 Watts per server (e.g., 3.0 Watts-4.0 Watts) depending on how much power and/or energy is utilized by the server in a regular off state, hibernate state, and/or sleep state. The system 330 is able to put a portion of servers into a deep off power state since the manager 332 is capable of monitoring and/or controlling functionality of each of the plurality of servers within the shared computing infrastructure 334. That is, previous systems and methods utilize each of the plurality of servers to monitor corresponding power management requests that are utilized to determine when to power on each of the plurality of servers.

FIG. 4 illustrates a flow chart 450 of an example of providing deep off power states consistent with the present disclosure. The flow chart 450 can be executed via a system and/or computing device as described herein in reference to FIG. 1 and FIG. 2. The flow chart 450 can be utilized to provide a number of deep off power states for a portion or all of a plurality of servers within a shared computing infrastructure (e.g., shared computing infrastructure 334 as referenced in FIG. 3, etc.).

At box 452, providing deep off power states can include receiving a number of power management requests from a number of servers. As described herein, a manager (e.g., manager engine 106 as referenced in FIG. 1, manager module 222 as referenced in FIG. 2, manager 332 as referenced in FIG. 3, etc.) can be utilized to monitor and/or control a number of servers within a shared computing infrastructure. The manager can receive the number of power management requests and/or workload requests and utilize this information when determining if there needs to be changes to servers within the shared computing infrastructure. The power management requests can indicate a power requirement (e.g., power needed to execute functions of the server) for each of the plurality of servers within the shared computing infrastructure.

At box 454, providing deep off power states can include determining an energy utilization for the number of servers based on the number of power management requests. Determining the energy utilization for the number of servers can include determining a quantity of energy to distribute to each of the number of servers based on the power management requests. For example, a manager can determine a percent energy utilization for a particular server based on a workload of the particular server and/or a workload of the shared computing infrastructure. In some examples, the energy utilization for a particular server can be based on a percent energy utilization the particular server will utilize when performing the functions of a particular workload.

At box 456, providing deep off power states can include removing an electrical energy connection from a portion of the number of servers based on the energy utilization. As described herein, removing an electrical energy connection can put the portion of the number of servers into a deep off power state. In some examples, removing the electrical energy connection can include putting an electrical power switch into an off position and disconnecting the portion of the number of servers from a power source such as power distribution unit. The portion of the number of servers can include servers that are determined unnecessary for providing resources for a particular workload. For example, the portion of the number of servers may only be needed to handle relatively high traffic times such as during a business day and may not be needed during relatively low traffic times such as non-business hours.

As used herein, “a” or “a number of” something can refer to one or more such things. For example, “a number of widgets” can refer to one or more widgets. The above specification, examples and data provide a description of the method and applications, and use of the system and method of the present disclosure. Since many examples can be made without departing from the spirit and scope of the system and method of the present disclosure, this specification merely sets forth some of the many possible example configurations and implementations.

What is claimed is:

1. A system for deep off power states, comprising:
a manager engine to:
receive a number of power management requests from a number of servers;
determine an energy utilization for the number of servers based on the number of power management requests; and
remove an electrical energy connection from a portion of the number of servers based on the energy utilization.

2. The system of claim 1, wherein removing the electrical energy connection includes removing all electrical energy from the portion of the number of servers via an electronic power switch.

3. The system of claim 1, wherein the portion of the number of servers are utilizing no electrical energy when the electrical energy connection is removed.

4. The system of claim 1, comprising the manager engine to receive additional power management requests relating to the portion of the number of servers when the electrical energy connection is removed.

5. The system of claim 4, comprising the manager engine to reconnect the electrical energy connection to the portion of the number of servers based on the additional power management requests.

6. The system of claim 1, wherein the number of power management requests include request to power on and power off systems relating to the number of servers.

7. A system for deep off power states, comprising:
a first computing device to monitor power management requests for a second computing device;
the second computing device coupled to electrical energy via an electronic power switch;
the first computing device communicatively coupled to the electronic power switch; and
the first computing device to remove and reconnect electrical energy from the second computing device via communication with the electronic power switch.

8. The system of claim 7, wherein the first computing device removes and reconnects electrical energy from the second computing device based on the power management requests for the second computing device.

9. The system of claim 7, wherein removing electrical energy from the second computing device removes the second computing device from an electrical energy source.

10. The system of claim 7, wherein the electronic power switch is an electronic fuse.

11. The system of claim 7, wherein the second computing device is coupled to a power distribution unit via the electronic power switch.

12. The system of claim 11, wherein the second computing device receives no electrical energy from the power distribution unit when the first computing device removes electrical energy from the second computing device via the electronic power switch.

13. A system for deep off power states, comprising:
a shared computing infrastructure comprising:
a manager engine to monitor and control functionality of a number of computing devices, wherein the manager engine is communicatively coupled to an electronic power switch and wherein the electronic power switch connects a power distribution unit to the number of computing devices; and
the manager engine to enable and disable the electronic power switch based on monitored functionality of the number of computing devices.

14. The system of claim 13, wherein enabling the electronic power switch provides power from the power distribution unit to the number of computing devices.

15. The system of claim 13, wherein disabling the electronic power switch removes all power from the power distribution unit to the number of computing devices.
